(19) United States
(12) Patent Application Publication
(10) Pub. No.: US 2026/0310709 A1
(43) Pub. Date: Oct. 8, 2026

(54) Automatically Capturing Employment Regulations using Multi-Agent System

(71) Applicant: Intermezzo Inc., Menlo Park, CA (US)

(72) Inventors: Kumar Ramanathan, Sunnyvale, CA (US); Siddharth Ram, Menlo Park, CA (US)

(73) Assignee: Intermezzo Inc., Menlo Park, CA (US)

(21) Appl. No.: 19/351,805

(22) Filed: Oct. 7, 2025

Related U.S. Application Data
(63) Continuation-in-part of application No. 19/256,702, filed on Jul. 1, 2025.
(60) Provisional application No. 63/784,905, filed on Apr. 7, 2025.

(51) Int. Cl. G06F 16/34; G06Q 10/105

(52) U.S. Cl. CPC G06F 16/345; G06Q 10/105

(57) ABSTRACT

Systems and methods are provided for extracting and automatically summarizing employment laws, rules, and regulation enforced within various jurisdictions worldwide. In one implementation, a method includes a step of automatically conducting a knowledge capture task involving retrieval of employment information from reliable online resources, the employment information associated with employment laws, rules, and regulations relevant to a specific jurisdiction of interest. The method further includes a step of automatically applying the employment information to a chain-of-debate system including multiple stages, each stage including one or more agents configured to interpret and define the employment information for creating a summarization output. In addition, the method includes a step of automatically submitting the summarization output to an admin device to allow a user thereof to evaluate suitability of the summarization output for use in a Human Resources (HR) environment of an organization operating within the specific jurisdiction of interest.

### CROSS REFERENCE TO RELATED APPLICATION

The present application is a Continuation-in-Part (CIP) of U.S. patent application Ser. No. 19/256,702, filed Jul. 1, 2025, entitled “AI-Based Payroll Processing Platform,” which claims the benefit of priority to U.S. Provisional Patent Application No. 63/784,905, filed Apr. 7, 2025, entitled “AI-Based Payroll Processing Platform,” wherein the contents of each are incorporated by reference herein.

### TECHNICAL FIELD

The present disclosure relates generally to computing and artificial intelligence (AI). More particularly, the present disclosure relates to systems and methods for an AI-based global employment platform, such as for capturing official employment regulations.

### BACKGROUND

Payroll processing is a critical function within human capital management (HCM), integral to businesses in the United States and globally. Despite its importance, payroll technology often lags behind modern advancements, relying heavily on legacy systems and manual processes. Typically, payroll tasks are handled by back-office staff who manually perform calculations, verify time records, manage compliance with regulatory requirements, and submit tax filings. This manual-intensive approach remains prevalent domestically and is even more pronounced internationally, given varied regional regulations and less digitized systems. Core payroll capabilities—including time and attendance management, gross-to-net salary calculations, regulatory compliance, and tax filing—are predominantly controlled by a limited number of large, incumbent vendors. These vendors often provide legacy systems characterized by fragmented solutions that do not seamlessly integrate with broader human capital management platforms or third-party tools. As a result, payroll processing frequently involves multiple standalone products, creating data silos and causing significant friction points.

This fragmentation and reliance on outdated technology creates numerous operational inefficiencies, inaccuracies, and compliance risks, generating considerable frustration across the payroll ecosystem. Employers grapple with complexity, high administrative costs, and exposure to compliance errors. Employees often experience delays or errors in pay and benefits processing, negatively impacting their experience and satisfaction. Payroll vendors themselves face pressure to support disparate systems, maintain complex integrations, and address continuous regulatory changes, all of which contribute to operational strain and customer dissatisfaction. Consequently, there is a clear and urgent need for modernized, integrated payroll solutions that leverage automation, real-time data synchronization, and intuitive user experiences to address these pervasive challenges and improve outcomes for all stakeholders involved in the payroll process.

### BRIEF SUMMARY

The present disclosure describes systems and methods for knowledge capture functions, particularly for retrieving or extracting employment laws and regulations and creating a summarization of such laws for use within a Human Resources (HR) environment for employees within a company or organization. According to one implementation, a method includes a step of automatically conducting a knowledge capture task involving the retrieval of employment information from reliable online resources, the employment information associated with employment laws, rules, and regulations relevant to a specific jurisdiction of interest. Also, the method includes a step of automatically applying the employment information to a chain-of-debate system including multiple stages, each stage including one or more agents configured to interpret and define the employment information for creating a summarization output. The method further includes a step of automatically submitting the summarization output to an admin device to allow a user thereof to evaluate suitability of the summarization output for use in a Human Resources (HR) environment of an organization operating within the specific jurisdiction of interest.

In some embodiments, the multiple stages of the chain-of-debate system may include a modeler stage, a critic stage, and a judge stage. The critic stage, for example, may include at least a syntax agent, a rules agent, and a completeness agent. Also, according to some embodiments, a first set of agents of the modeler stage, a second set of agents of the critic stage, and a third set of agents of the judge stage may each be configured to operate according to a Mixture of Experts (MoE) technique, an ensemble learning technique, a committee technique, and/or an automated dialogue technique in order to attempt to reach a converging consensus. The modeler stage, for instance, may be configured to pass a first set of results to the critic stage, and the critic stage, for instance, may be configured to pass a second set of results to the judge stage. Also, the critic and judge stages may be configured to provide feedback to one of the previous stages as needed for clarification and/or for requesting more accurate or reliable results.

The method, according to some implementations, may further include a step of utilizing a coordinator agent configured between the admin device and the chain-of-debate system for enabling communication among the multiple stages of the chain-of-debate system and the admin device. Also, the method may include a step of testing results of the chain-of-debate system with real-world or fictitious employment data associated with the organization. The reliable online resources include government websites, for example, may be associated with employment regulations in multiple countries, states, or territories. In some embodiments, the method may further include a step of enabling a user associated with the admin device to craft prompts and agent role assigning instructions from configurable templates.

The chain-of-debate system, according to some embodiments, may include multiple agents arranged in a neural network, wherein roles of the multiple agents may include a) a knowledge capturer, b) an extractor, c) a language translator, d) a Natural Language Processor (NLP), e) a modeler, f) a critic, g) a syntax analyzer, h) a rules analyzer, i) a completeness analyzer, j) a ranking scorer, k) a judge, l) a human-in-the-loop verifier, m) a coordinator, n) a final output tester, o) a validator, and/or p) a compliance analyzer. Furthermore, the one or more agents of each of the multiple stages may include Artificial Intelligence (AI) agents employing Large Language Models (LLMs) and/or Generative AI (GenAI) models.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 illustrates an Employee Lifecycle, encompassing Human Capital Management (HCM) activities, according to various embodiments.

FIG. 2 is a flow diagram illustrating payroll processing steps, highlighting human intervention, according to various embodiments.

FIG. 3 is a block diagram illustrating a computing system that enables payroll processing functionality, according to various embodiments.

FIG. 4 illustrates a block diagram of an AI-based payroll processing platform, emphasizing automation and advanced data management, according to various embodiments.

FIG. 5 illustrates a detailed layered diagram illustrating the functional architecture of the AI-based payroll processing platform, emphasizing the structured approach of the system through three distinct, integrated layers, according to various embodiments.

FIG. 6 illustrates functional operation of a Knowledge Engine within the AI-based payroll processing platform, specifically highlighting the mechanism by which regulatory information is continuously monitored, validated, and updated, according to various embodiments.

FIG. 7 illustrates a detailed functional diagram of a Gross-to-Net Engine within the AI-based payroll processing platform, according to various embodiments.

FIG. 8 illustrates a detailed functional diagram of the Tax Filing Engine within the AI-based payroll processing platform, highlighting automated generation and transfer of tax schedules and payments to regulatory agencies, according to various embodiments.

FIG. 9 illustrates an architectural diagram of the AI-based, API-first payroll processing platform, emphasizing the integration of advanced artificial intelligence, robust APIs, and comprehensive compliance mechanisms, according to various embodiments.

FIG. 10 illustrates a comprehensive functional diagram of the AI-based payroll platform, emphasizing its API-driven architecture, robust integration capabilities, strategic partnerships, and modern technology stack, according to various embodiments.

FIG. 11 is a flow diagram illustrating a method for performing payroll processing activities, according to various embodiments.

FIG. 12 is a diagram illustrating an embodiment of an HR system having an HR Operations Platform serving as a unified hub that orchestrates multiple operational functionalities essential to comprehensive human capital management, according to various embodiments.

FIG. 13 is a flow diagram illustrating an automated method for performing payroll processing operations, according to various embodiments.

FIG. 14 is a block diagram illustrating a knowledge capture system, according to various embodiments.

FIG. 15 is a block diagram illustrating the HR assistance system shown in FIG. 14, according to various embodiments.

FIG. 16 is a block diagram illustrating an agent instructing system, according to various embodiments.

FIG. 17 is a flow diagram illustrating an embodiment of a method for automatically retrieving and summarizing employment regulations for enforcement purposes within an organization, according to various embodiments.

### DETAILED DESCRIPTION

To address these challenges, the present disclosure provides an innovative payroll platform leveraging AI. This platform is designed as a global solution rather than being limited to any single country or region, aiming to efficiently manage payroll operations across most major countries. One of the main objectives is to significantly redesign and improve the payroll industry, characterized by traditionally low Net Promoter Scores (NPS) and operational burdens, by creating a streamlined, unified, and highly integrated global HR operations platform for payroll. By utilizing AI-driven automation, real-time data synchronization, and a user-centric design, the systems and methods of the present disclosure aim to simplify payroll processes, enhance accuracy and compliance, and dramatically improve satisfaction for employers, employees, and payroll vendors alike.

### Employee Lifecycle

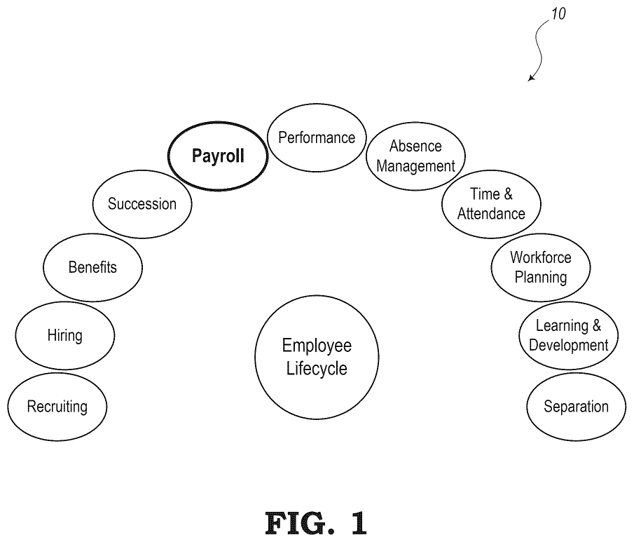

FIG. 1 illustrates an embodiment of an Employee Lifecycle 10, encompassing Human Capital Management (HCM) activities arranged in an arc around a central circle labeled “Employee Lifecycle.” The components of the Employee Lifecycle 10 include Recruiting, Hiring, Benefits, Succession, Payroll, Performance, Absence Management, Time & Attendance, Workforce Planning, Learning & Development, and Separation. Each component may be represented by a distinct icon and color to emphasize the interconnected, yet distinct functions involved in managing employee experiences from entry to exit within an organization.

Focusing specifically on Payroll, Payroll may be viewed as one of the central activities within the Employee Lifecycle 10. This placement underscores the payroll's pivotal role in HCM, emphasizing its foundational importance. Despite its centrality, payroll management faces substantial operational challenges. These include manual calculations, complex compliance requirements across different jurisdictions, fragmented solutions, and difficulties integrating with other HCM components such as Time & Attendance, Benefits, and Performance Management. These challenges contribute significantly to operational inefficiencies and dissatisfaction among employers, employees, and payroll vendors, further illustrating the need for innovative and integrated payroll solutions. The embodiments of the present disclosure are configured to overcome some or all of these shortcomings.

Payroll issues may consistently cause significant operational strain and dissatisfaction among payroll providers, employers, and employees alike. Common payroll problems include frequent overpayments, missed payments, inaccuracies in compensation, incorrect tax deductions, delayed reimbursements, and other errors impacting financial accuracy and compliance. These persistent issues not only frustrate employees—damaging their trust and engagement—but also increase administrative costs and risks for employers and payroll service providers.

Recent industry surveys indicate that Chief Information Officers (CIOs) are increasingly prioritizing improvements in payroll operational efficiency, recognizing payroll processing as a critical area for optimization. The heightened attention reflects a strategic shift toward investing in technology-driven solutions, including advanced automation, integrated platforms, and AI-driven systems, aimed at minimizing payroll errors, enhancing compliance, and ultimately improving the employee experience.

Additionally, there are several critical considerations for C-suite executives, including CIOs, Chief Financial Officers (CFOs), and Chief Human Resources Officers (CHROs). These include maintaining strategic flexibility to expand globally while hiring locally within international markets. Moreover, there is an increasing demand for continuous payroll processing and earned wage access capabilities, which is essential for attracting and retaining talent in highly competitive labor environments. Finally, executives must prioritize reducing payroll operation costs by innovatively leveraging advanced technology solutions.

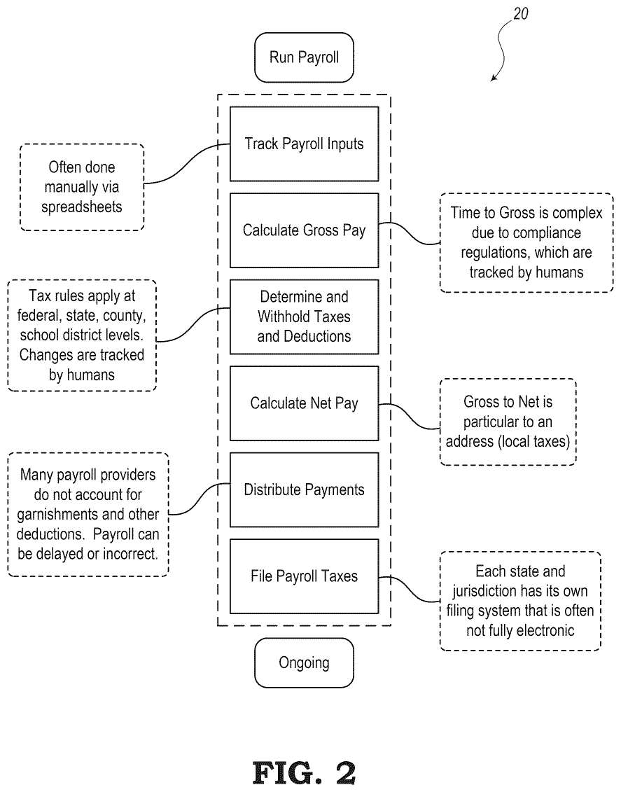

FIG. 2 is a diagram illustrating a process 20 for performing traditional payroll processing steps, highlighting extensive human intervention, which may typically render payroll operations costly, slow, and susceptible to errors. The process 20 of FIG. 2 shows a sequential workflow labeled “Run Payroll,” encompassing multiple critical activities:
(1) Track Payroll Inputs: This step often involves manual data entry via spreadsheets, making the initial stage labor-intensive and prone to human error.
(2) Calculate Gross Pay: This calculation, known as “time to gross,” is particularly complex due to varying compliance requirements across jurisdictions. Such complexity necessitates significant manual oversight, increasing potential inaccuracies.
(3) Determine and Withhold Taxes and Deductions: Payroll taxes involve multilayered rules applied at federal, state, county, and even school district levels. Tracking and adjusting for regulatory changes typically rely on manual updates, further elevating the risk of non-compliance or errors.
(4) Calculate Net Pay: The “gross-to-net” calculation step frequently involves local or address-specific tax considerations, demanding precise attention from payroll administrators and increasing the likelihood of miscalculations.
(5) Distribute Payments: Payment distribution processes are often complicated by garnishments, court-ordered deductions, and other special circumstances. Many existing payroll providers lack automated mechanisms to reliably account for these deductions, frequently resulting in delayed or incorrect employee payments.
(6) File Payroll Taxes: Finally, tax filing involves interactions with multiple state and jurisdictional filing systems, many of which are not fully digitized. This lack of electronic integration requires substantial manual intervention, elevating administrative burdens and compliance risks.

The process 20 also includes ongoing, continuous payroll management activities and underscores the inefficiencies inherent to traditional payroll operations. FIG. 2 makes clear the operational need for technology-driven solutions to minimize manual inputs, streamline payroll workflows, and improve accuracy and compliance.

### General-Purpose Computer

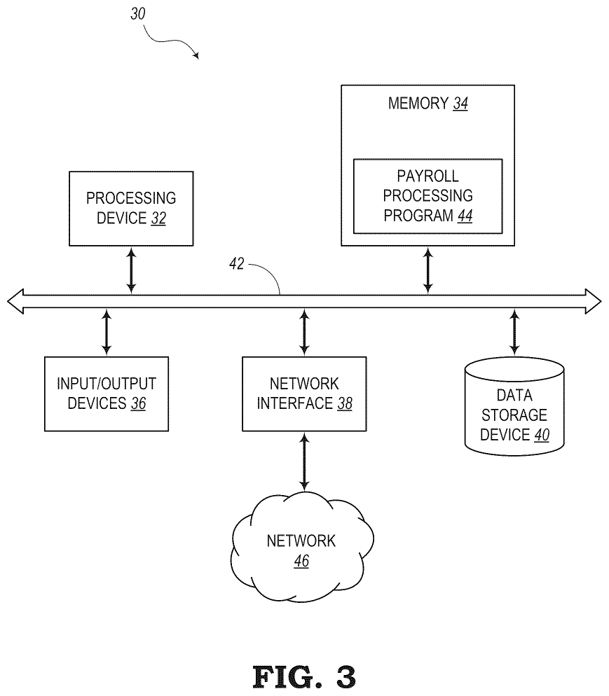

FIG. 3 is a block diagram illustrating an embodiment of a computing system 30 that enables payroll processing functionality according to the embodiments of the present disclosure. As shown in simplified form, the computing system 30 includes a processing device 32, memory 34, Input/Output (I/O) devices 36, a network interface 38, and a data storage device 40, all communicatively coupled via a local interface 42.

The processing device 32 may include one or more processors, such as a Central Processing Unit (CPU), and may further include or be coupled to one or more specialized processing units, such as a Graphics Processing Unit (GPU), a Digital Signal Processor (DSP), a Network Processor (NP), a Field Programmable Gate Array (FPGA), and/or an Application-Specific Integrated Circuit (ASIC). The processing device 32 is configured to execute software instructions and manage operations of the computing system 30, including coordinating communication across components via the local interface 42. In some embodiments, the processing device 32 may implement logic through software, firmware, hardware, or any combination thereof, and may be characterized as “circuitry configured to” perform certain functions.

The memory 34 may include any combination of volatile and non-volatile memory technologies, such as Random Access Memory (RAM), Dynamic RAM (DRAM), Synchronous DRAM (SDRAM), Static RAM (SRAM), Read-Only Memory (ROM), Programmable Read-Only Memory (PROM), Erasable Programmable Read-Only Memory (EPROM), Electrically Erasable Programmable Read-Only Memory (EEPROM), flash memory, etc. The memory 34 stores operating system software, application programs, data, and other executable instructions. In some implementations, the memory 34 may be distributed or hierarchically organized and accessed by the processing device 32 over the local interface 42. The memory 34 may also include a cache, buffers, or a memory management unit.

The Input/Output (I/O) devices 36 facilitate user interaction and system integration, and may include input devices such as keyboards, mice, touchscreens, and microphones, as well as output devices such as displays, printers, speakers, and haptic interfaces. The I/O devices 36 may also include peripheral sensors (e.g., biometric scanners, cameras) and may be directly connected to or communicate wirelessly with the computing system 30, including via the network interface 38.

The network interface 38 enables the computing system 30 to communicate with external networks, such as network 46, the Internet, a local area network (LAN), or a wide area network (WAN). The network interface 38 may include wired or wireless interfaces (e.g., Ethernet, Wi-Fi, Bluetooth) and support various protocols including TCP/IP, UDP, and others. It may include built-in security mechanisms such as encryption, firewalls, or authentication features, and may be implemented as an integrated or discrete module.

The data storage device 40 provides persistent storage for digital information and may include a Hard Disk Drive (HDD), Solid-State Drive (SSD), and/or other non-volatile storage technology. In some embodiments, the data storage device 40 may function as a database or be coupled to an external data store, supporting efficient retrieval, indexing, and management of data. The data storage device 40 may be local to the system or remotely accessible via the network interface 38.

The local interface 42, also referred to as a bus interface, provides the communication backbone for data exchange among components. It may include one or more buses or communication channels, such as a memory bus, I/O bus, or system bus, and may conform to protocols such as PCI, USB, AMBA, or others. The local interface 42 may also include address, data, and control lines, and additional circuitry such as buffers, repeaters, or controllers to ensure efficient and synchronized operation of the system.

In operation, the processing device 32 executes instructions from the memory 34, exchanges data with the I/O devices 36, communicates externally via the network interface 38, retrieves and stores persistent data on the data storage device 40, and coordinates all component interactions over the local interface 42 to implement the described functionality.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions described in the present disclosure. Such non-transitory computer-readable storage mediums can include, but are not limited to, hard disks, optical storage devices, magnetic storage devices, ROM, PROM, EPROM, EEPROM, flash memory, etc. The software stored in these media includes executable instructions that, upon execution by one or more processors or any programmable circuitry, enable, cause, or instruct the processor or circuitry to undertake a series of operations, steps, methods, processes, algorithms, functions, or techniques as detailed herein for the various embodiments.

Also, the computing system 30 includes a payroll processing program 44, which may be implemented in any suitable combination of hardware (e.g., in the processing device 32) and/or software or firmware (e.g., in the memory 34 or other non-transitory computer-readable media). The payroll processing program 44 is configured to execute various functions as described herein for improving conventional systems, thereby simplifying the tasks for human operators, reducing errors, etc.

### AI-Based Payroll Platforms

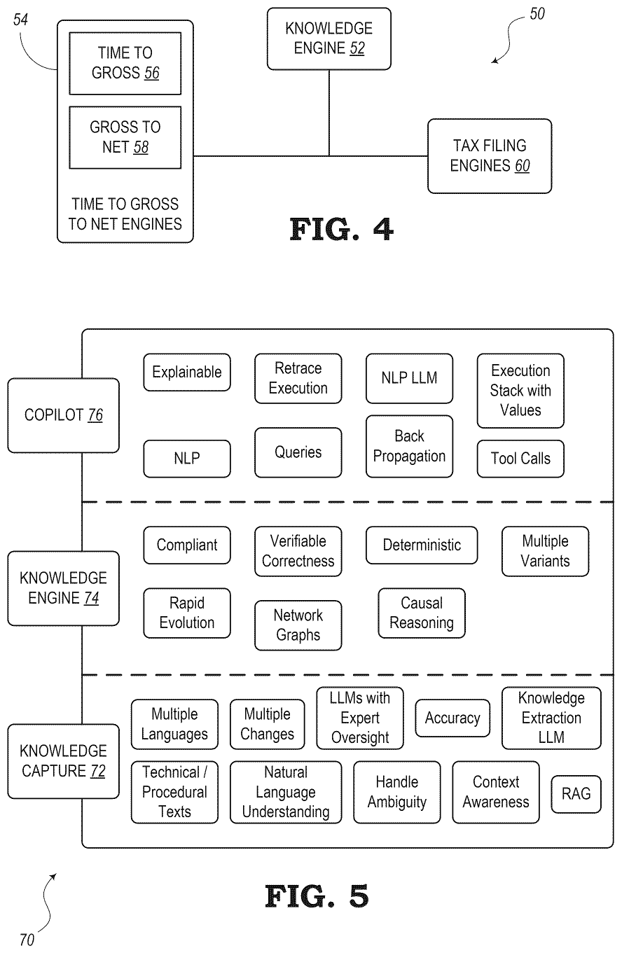

FIG. 4 illustrates a block diagram of an AI-based payroll processing platform 50, emphasizing automation and advanced data management. In some embodiments, the AI-based payroll processing platform 50 may be configured as part of the payroll processing program 44 shown in FIG. 3. The AI-based payroll processing platform 50 includes a Knowledge Engine 52, which employs multiple intelligent agents designed to systematically discover, aggregate, and structure diverse payroll-related data. This knowledge harvesting process involves automatically gathering and organizing relevant inputs such as employee hours, compensation details (including commissions, overtime, and sick leave), regulatory updates, and tax information, making it readily consumable by downstream processes. The AI-based payroll processing platform 50 also includes time-to-gross-to-net engines, which include a time-to-gross engine 56 and a gross-to-net engine 58. Furthermore, the AI-based payroll processing platform 50 includes tax filing engines 60.

The structured data from the Knowledge Engine 52 feeds into specialized computational engines:
(1) Time to Gross Engine 56: This engine initially receives and processes raw time data inputs such as regular work hours, overtime, commissions, bonuses, and various forms of leave (e.g., sick pay, vacation time). It accurately converts these diverse payroll inputs into a gross compensation amount, ensuring full compliance with local labor regulations and employment contracts.
(2) Gross to Net Engine 58: Once the gross salary has been calculated, the Gross to Net Engine further refines this calculation. It systematically accounts for all employee-specific deductions, including both pre-tax contributions (e.g., retirement accounts, health insurance) and post-tax deductions (e.g., wage garnishments). This engine meticulously incorporates local, state, and federal tax obligations relevant to the geographical location of both the employee and employer, resulting in precise net salary figures ready for distribution.
(3) Tax Filing Engines 60: Following accurate net-pay calculations, automated tax filing engines generate contextualized tax schedules and filings. These engines automatically compute amounts owed and facilitate the timely submission of required payments and documentation to federal, state, and local tax regulatory agencies, significantly reducing administrative overhead and minimizing compliance risks.

Together, these interconnected components of the AI-based payroll processing platform 50 leverage artificial intelligence to streamline the payroll process end-to-end, enhancing efficiency, accuracy, compliance, and overall satisfaction across payroll stakeholders.

FIG. 5 illustrates an embodiment of a layered system 70 and shows the functional architecture of the AI-based payroll processing platform 50 of FIG. 4 and/or other payroll processing systems, emphasizing the structured approach of the layered system 70 through three distinct, integrated layers:
(1) Knowledge Capture Layer 72 (Bottom Layer): This foundational layer leverages advanced Large Language Models (LLMs) enhanced by expert oversight to interpret and capture complex, multilingual inputs, including technical and procedural payroll texts. Key capabilities of this layer include robust natural language understanding (NLU), the ability to handle ambiguity, context-awareness, and adaptability to frequent changes in payroll-related regulations and procedures. Intelligent agents within this layer convert the captured payroll information into structured representations, specifically state machines, facilitating accurate interpretation and standardization of diverse input sources.
(2) Knowledge Engine Layer 74 (Middle Layer): Building upon the structured information captured by the bottom layer, the Knowledge Engine employs deterministic computational methodologies, primarily through sophisticated network graphs, to execute the previously constructed state machines. This layer ensures compliance, deterministic calculations, verifiable correctness, and thorough testing. The deterministic nature of this layer allows for precise, causal reasoning, enabling the handling of multiple variants and rapid adaptation to evolving regulatory and organizational contexts. By transforming probabilistic inputs into deterministic outputs, this layer delivers consistent, accurate payroll computations.
(3) Copilot Interaction Layer 76 (Top Layer): At the highest level, the Copilot layer utilizes natural language processing (NLP)-enabled LLMs to provide transparent, user-friendly interaction. A unique feature of this layer is its capability to deliver detailed explanations for specific payroll queries, such as clearly answering employee inquiries like, “Why was $131.21 deducted from my paycheck for FICA?” This top layer, through advanced retrace execution capabilities, can precisely detail the step-by-step computational and regulatory logic that led to specific payroll outcomes. This explanatory capability surpasses current market standards by providing unprecedented transparency and clarity to users regarding payroll-related questions.

Collectively, these three layers form what is termed an “LLM sandwich,” seamlessly integrating probabilistic interpretation at the bottom, deterministic computational execution in the middle, and probabilistic yet highly explainable user interactions at the top, enabling a robust, transparent, and highly accurate AI-based payroll processing platform.

In addition, the layered system 70 of FIG. 5 illustrates more in-depth functional architecture of the AI-based payroll processing platform 50. Furthermore, the layered system 70 delineates explicit interactions and internal mechanisms across the three distinct, interconnected layers of the system:
(1) Knowledge Capture Layer 72: The foundational layer in FIG. 5 expands on knowledge extraction capabilities utilizing a sophisticated multi-agent system incorporating advanced Large Language Models (LLMs). This layer continuously monitors primary data sources through Retrieval-Augmented Generation (RAG), incorporates structured data extraction, performs self-validation, and leverages tool calls for enhanced accuracy.

An essential innovation highlighted here is the integration of “Multiple Critics,” advanced agent-based critique mechanisms including an LLM-based judge and domain-specific experts. These critics assess the extracted information for accuracy, completeness, and contextual appropriateness, and they signal any disagreements or gaps that require correction. Crucially, this layer also includes a human-in-the-loop component, employing Reinforcement Learning with Human Feedback (RLHF), recognizing the need for nuanced human judgment to refine the system's outputs. This combined human-agent critic approach addresses the complexity, ambiguity, and variability inherent in payroll data, ensuring high-quality structured outputs.

In addition to jurisdiction specific structured information, this knowledge capture layer is able to analyze company specific policies and any collective bargaining agreements with unions or other employee organizations, to dynamically customize the state machine to meet the obligations outlined in these documents.
(2) Knowledge Engine Layer 74: The middle layer serves as the primary computational and runtime engine of the payroll platform. Explicitly depicted are “Network Graphs,” which represent deterministic computational state machines derived from structured inputs provided by the Knowledge Capture Layer. This layer is entirely non-probabilistic and non-LLM based, operating via computational graph logic to maintain determinism and reliability. Additionally, this layer employs a Constraint Verification Algorithm, meticulously validating computations for compliance and correctness against predefined business rules and payroll regulations. The deterministic nature of this layer assures precise, reproducible, and verifiable payroll computations, critical for regulatory compliance and operational integrity.
(3) Copilot Interaction Layer 76: At the highest level, the Copilot layer returns to an LLM-based model, designed for sophisticated user interaction. This layer employs an NLP-based Large Language Model (LLM) integrated with tool-calling capabilities and maintains a comprehensive execution stack with detailed values. Crucially, it utilizes a powerful Back-Propagation method, enabling the LLM to systematically retrace the execution paths through the network graphs. This functionality provides users with transparent, detailed explanations, allowing them to clearly understand the computational logic behind specific payroll outcomes or deductions. By effectively walking backwards through the computational graphs, this top layer delivers unmatched transparency and insight into the payroll decision-making process, thus significantly enhancing user trust and satisfaction.

Collectively, FIG. 5 elaborates on the robust, integrated, and layered nature of the AI-driven payroll platform, clearly delineating the critical roles of probabilistic, deterministic, and explanatory mechanisms within a coherent, highly effective computational structure.

### Knowledge Engine

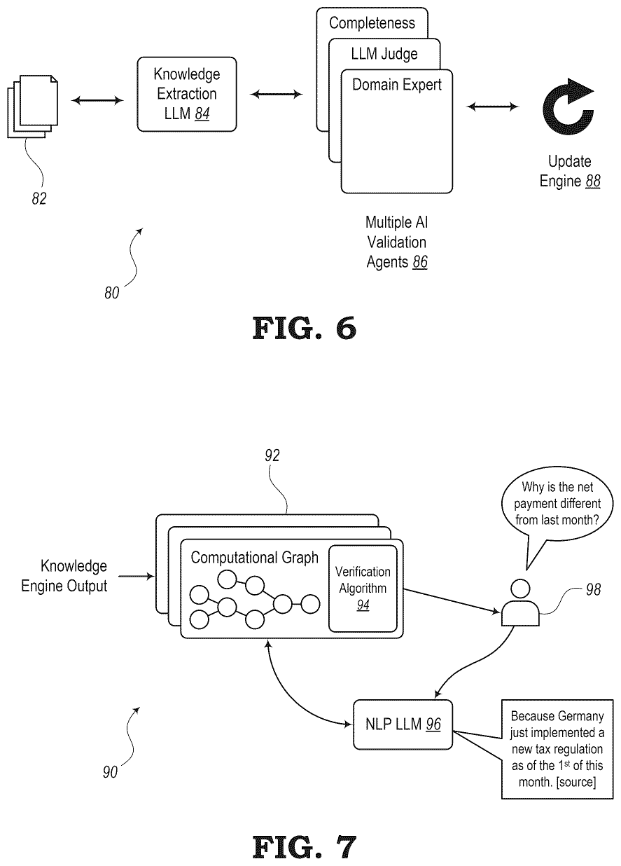

FIG. 6 illustrates an embodiment of the functional operations of a Knowledge Engine 80 (e.g., Knowledge Engine 52, 74, etc.) within the AI-based payroll processing platforms and layered systems, specifically highlighting the rigorous mechanism by which regulatory information is continuously monitored, validated, and updated. AI may constantly monitor changing regulations and may update upon agent agreement. The figure depicts a sequential workflow emphasizing accuracy and reliability:
(1) Regulatory Data Sources: On the left side of FIG. 6, regulatory documents and updates 82 are collected from various sources. These regulatory documents and updates 82 encompass multiple languages, reflecting the international scope of payroll operations. The inputs are also technical and procedural in nature, emphasizing the complexity and precision required in payroll compliance. Notably, these regulatory inputs are constantly changing, necessitating continuous monitoring.
(2) Knowledge Extraction LLM 84: The next component involves a sophisticated Large Language Model (LLM) dedicated to knowledge extraction. This LLM systematically processes the diverse regulatory inputs, translating complex and multilingual regulatory documentation into structured, standardized formats suitable for computational analysis. It ensures rapid and consistent integration of regulatory updates into the payroll platform.
(3) Multiple AI Validation Agents 86: To ensure maximal accuracy, the structured outputs from the Knowledge Extraction LLM 84 are rigorously evaluated by multiple specialized AI, mathematical, and human expert agents:
   (a) Completeness Agent: Validates that all necessary regulatory details have been captured and no critical information has been omitted.
   (b) LLM Judge: Employs an advanced LLM to critically assess the logical consistency and correctness of the extracted knowledge, ensuring semantic accuracy and contextual appropriateness.
   (c) Domain Expert Agent: Simulates the role of a human expert, applying deep domain-specific knowledge to verify the regulatory information for practical applicability and compliance accuracy. These validation agents collaboratively review, critique, and refine extracted knowledge, establishing consensus through multi-agent agreement before approval.
(4) Update Engine 88: Upon achieving validation consensus, confirmed updates are transmitted to the Update Engine 88. This component automatically incorporates validated regulatory changes into the payroll platform's Knowledge Engine, ensuring that all computational operations and payroll decisions reflect the most current and accurate regulatory compliance requirements.

Together, these components create a robust, self-validating feedback loop, continuously refining and updating the knowledge base underpinning payroll operations, thus ensuring ongoing compliance, accuracy, and reliability.

### Gross to Net Engine

FIG. 7 illustrates a detailed functional diagram of a Gross-to-Net Engine 90 (e.g., gross-to-net engine 58) within the AI-based payroll processing platform. The diagram specifically emphasizes how computational graphs 92 deterministically perform payroll calculations and enable comprehensive query and explanation capabilities.
(1) Knowledge Engine Output: On the left side, FIG. 7 depicts structured payroll knowledge outputs derived from the platform's Knowledge Engine (e.g., Knowledge Engine 52, 74) described above. These outputs encapsulate payroll rules, regulations, tax information, and deduction guidelines. The Knowledge Engine 90 ensures these outputs are consistently compliant, verifiably correct through rigorous validation processes, and constantly updated to reflect the latest regulatory and operational standards.
(2) Computational Graph 92: At the center of FIG. 7, computational graphs 92 receive structured data from the Knowledge Engine 90. These graphs represent deterministic payroll calculations, executing precise and transparent computations from gross salary figures to final net pay. Each node within the computational graph 92 denotes a specific calculation step (e.g., tax deductions, pre-tax contributions, post-tax adjustments), clearly illustrating the sequential and dependent relationships between these payroll calculation steps. The graph supports conditional flows through branching, composition through recursive execution of graphs & sub-graphs, support for multiple versions based on effective dates & company-specific policies and automated execution tracking by registering visited nodes during execution.
(3) Verification Algorithm 94: Embedded within the computational graph 92 structure is a Verification Algorithm 94. This algorithm systematically verifies each calculation step, ensuring every node and computational pathway adheres strictly to predefined payroll rules and regulatory constraints. This rigorous verification mechanism guarantees accuracy, compliance, and reliability of payroll outcomes.
(4) Natural Language Processing (NLP) LLM 96: The gross-to-net engine 90 of FIG. 7 further introduces an NLP-based Large Language Model (LLM) 96 designed to provide interactive query and explanation capabilities. Users 98, such as employees or payroll administrators, can pose detailed, natural-language questions (e.g., “Why is the net pay different from last month?”). The NLP engine interacts seamlessly with the computational graphs 92, enabling it to accurately retrace calculation steps and offer clear, contextualized explanations. For example, the LLM might explain variations in net pay by pointing to recent regulatory changes, explicitly stating reasons such as, “Because Germany just implemented a new tax regulation as of the 1st of this month.”

This integration of deterministic computational graphs with advanced NLP-based query capabilities provides unparalleled transparency, accuracy, and responsiveness in payroll processing. Employees and employers alike benefit from a precise understanding of payroll computations, fostering trust and satisfaction across all payroll stakeholders.

### Tax Filing Engine

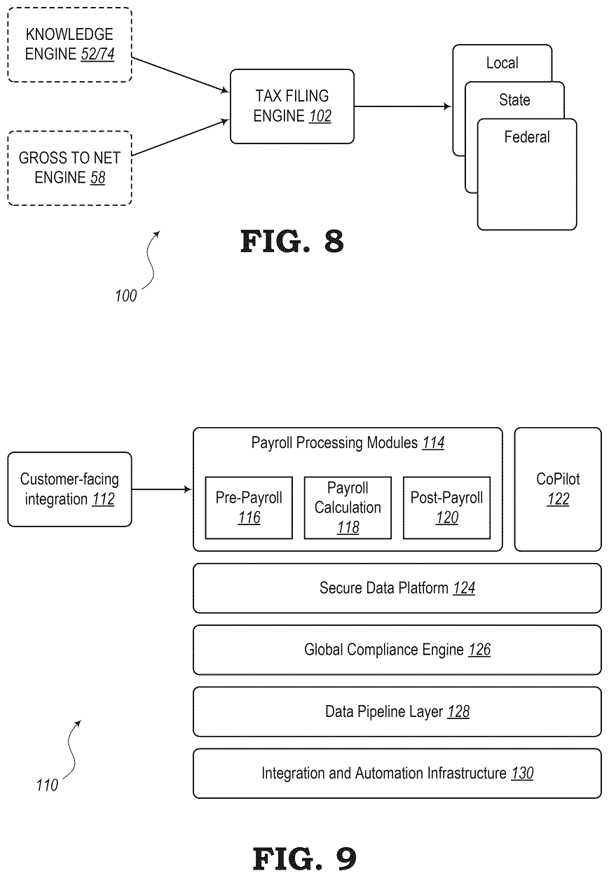

FIG. 8 illustrates an embodiment of a detailed functional diagram of a system 100 using a Tax Filing Engine 102 within the AI-based payroll processing platform, highlighting automated generation and transfer of tax schedules and payments to regulatory agencies. In some embodiments, the Tax Filing Engine 102 may be the same or similar to the tax filing engines 60 described with respect to FIG. 4.
(1) Inputs from Knowledge Engine 52/74/90 and Gross-to-Net Engine 58: On the left side of FIG. 8, the Knowledge Engine 52/74/90 and the Gross-to-Net Engine 58 provide structured inputs. The Knowledge Engine contributes continuously updated, verified regulatory information, including accurate tax rates, jurisdiction-specific requirements, filing schedules, and compliance guidelines. The Gross-to-Net Engine supplies finalized, verified payroll calculation results, detailing employee net pay, applicable taxes, deductions, and liabilities.
(2) Tax Filing Engine 102: At the center, the Tax Filing Engine 102 systematically integrates the inputs from both engines to generate comprehensive tax filing schedules. This engine automates preparation and submission processes, calculating precise tax obligations across multiple regulatory levels, including local, state, and federal jurisdictions. The Tax Filing Engine 102 ensures accurate tax calculations, applies jurisdiction-specific rules automatically, schedules timely payments, and prepares complete filing documentation, significantly reducing the potential for human error and non-compliance.
(3) Automated Regulatory Submission: On the right, FIG. 8 shows the automatic transfer of generated tax schedules and payments directly to relevant regulatory agencies—clearly categorized into Local, State, and Federal entities. This automated process ensures timely, accurate, and compliant submissions to all appropriate government bodies, facilitating seamless regulatory compliance and minimizing administrative burdens. Regulatory filings requirements vary based on jurisdiction, size of payroll, number of employees, type of industry and a wide array of other parameters based on wage tax laws. These are automatically tracked and filed as needed for each payroll run, monthly, quarterly, and annually.

Overall, the system 100 of FIG. 8 emphasizes the seamless integration, automation, and efficiency enabled by the AI-based payroll platform's Tax Filing Engine 102, ensuring accuracy, compliance, and operational reliability while significantly streamlining the tax reporting process.

### Payroll Processing Architecture

FIG. 9 illustrates a detailed architectural diagram of an AI-based, API-first payroll processing platform 110, emphasizing the integration of advanced artificial intelligence, robust APIs, and comprehensive compliance mechanisms. The AI-based, API-first payroll processing platform 110 is organized into clearly defined functional components, underpinned by secure data management and dynamic, agentic compliance engines:
(1) Customer-Facing Integration 112: At the far left, FIG. 9 shows customer-facing integration 112 points enabled through APIs. This integration layer accepts various employee-specific data inputs including employee profiles (PII), compensation details, time cards, time-off, expense submissions, benefits enrollment, equity distributions, garnishments, and ad-hoc payroll adjustments. These data inputs are critical for accurate payroll processing and compliance management.
(2) Payroll Processing Modules 114: Centrally, the architecture is structured into three core processing modules:
   (a) Pre-Payroll Module 116: Handles initial payroll preparation tasks such as defining payroll policies, calendars, and deadlines. It includes automated input collection and thorough input validation, ensuring accuracy before payroll calculations commence.
   (b) Payroll Calculation Module 118: Performs critical payroll computations, including the calculation of employee gross earnings, deductions, taxes, and resulting net pay. This module leverages deterministic computational logic to maintain accuracy, compliance, and transparency in payroll processing.
   (c) Post-Payroll Module 120: Manages final payroll activities, including disbursement of payments, statutory tax filings, payroll accounting entries, and generation of detailed management reports. These processes ensure that payroll outcomes are correctly executed, documented, and auditable.
(3) CoPilot 122 (Interactive AI Module): To the right, the CoPilot 122 module provides advanced, AI-driven interactive guidance for both HR professionals and employees. Key features include HR compliance guidance, employee compliance insights, and detailed payroll analytics to enhance understanding and transparency of payroll outcomes.
(4) Supporting Layers and Capabilities: Below the primary modules, the diagram details the supporting layers and foundational capabilities of the platform:
   (a) Secure Data Platform 124: Offers robust data management within a multi-tenant environment, ensuring data security, integrity, scalability, and compliance across multiple customer organizations.
   (b) Global Compliance Engine 126: Incorporates advanced agentic AI mechanisms combined with reinforcement learning through human feedback (RLHF) to continuously update regulatory information, ensuring ongoing compliance across diverse global jurisdictions. This compliance engine is dynamic, accurate, and always current.
   (c) Data Pipeline Layer 128: Acts as a single-source repository providing compliant, verifiable, and auditable data flow between modules. The data pipeline is enhanced with expert-driven AI review (RLHF), ensuring ongoing accuracy and adaptability to regulatory changes.
   (d) Integration and Automation Infrastructure 130: At the bottom, robust technical infrastructure elements are depicted, including open APIs, extensive data connectors, comprehensive security and governance controls, and automation frameworks. This foundation ensures seamless integration, streamlined operations, and robust data management capabilities throughout the payroll platform.

Collectively, the AI-based, API-first payroll processing platform 110 of FIG. 9 conveys a highly integrated, AI-enhanced, API-first payroll platform designed to optimize payroll accuracy, compliance, efficiency, and user experience, fundamentally transforming traditional payroll operations through advanced automation, intelligent compliance management, and intuitive user interactions.

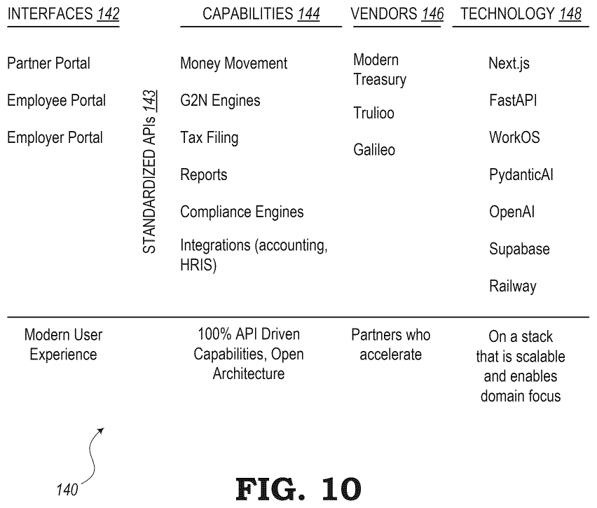

FIG. 10 illustrates a table 140 showing a functional diagram of the AI-based payroll platforms described in the present disclosure, emphasizing its API-driven architecture, robust integration capabilities, strategic partnerships, and modern technology stack. FIG. 10 is structured into distinct yet interconnected functional sections, demonstrating the platform's breadth and flexibility:
(1) Interfaces 142 (Portals): At the left, the table 140 shows that the platform provides specialized portals designed for different stakeholders: Partner Portal: Allows seamless integration and interactions with external service partners. Employee Portal: Offers intuitive access for employees to view pay stubs, tax information, submit queries, and manage personal payroll details. Employer Portal: Facilitates employer-level tasks including payroll management, reporting, compliance oversight, and administrative controls. These interfaces collectively deliver a modern, intuitive user experience tailored to the needs of various platform users.
(2) Standardized APIs 143: Centrally positioned between sections, standardized APIs form the core connectivity backbone, enabling effortless data exchange, seamless integration, and interoperability with both internal components and external systems. These APIs underpin a fully open architecture and support comprehensive API-driven functionalities.
(3) Capabilities 144: The platform's core functional capabilities include:
   (a) Money Movement: Automated handling of payroll disbursements, international payments, and real-time financial transactions.
   (b) Gross-to-Net (G2N) Engines: Robust, deterministic payroll computation engines accurately converting gross earnings to net pay considering multiple deductions and regulatory rules.
   (c) Tax Filing: Automated compliance with accurate generation, scheduling, and submission of local, state, and federal tax filings.
   (d) Reports: Comprehensive payroll reporting and analytics, supporting detailed operational insights and compliance audits.
   (e) Compliance Engines: Continuously updated compliance systems managing regulatory requirements globally and regionally.
   (f) Integrations (Accounting, HRIS): Seamless integrations with external systems, including accounting platforms and Human Resource Information Systems (HRIS), to ensure accurate data synchronization and streamlined workflows.
(4) Vendors 146 (Strategic Partners): To the right, the table 140 of FIG. 10 highlights strategic vendor relationships that extend the platform's capabilities and accelerate its deployment: Modern Treasury: Enhances automated money movement and payment capabilities. Trulioo: Provides comprehensive identity verification and compliance solutions. Galileo: Facilitates seamless financial management and card-based transaction integrations. These strategic partnerships significantly accelerate the platform's operational readiness, scale, and effectiveness.
(5) Technology Stack 148: At the far right, the modern and robust technology stack underpinning the platform is showcased:
   Next.js: Enables scalable and performant web applications.
   FastAPI: Supports fast, efficient, and secure API-driven backend development.
   WorkOS: Simplifies enterprise-ready identity and access management.
   PydanticAI: Enhances structured data validation and AI integration.
   OpenAI: Provides powerful natural language processing and generative AI capabilities.
   Supabase: Delivers scalable, secure, and real-time backend database services.
   Railway: Offers robust, scalable infrastructure management and rapid deployment capabilities.

The integrated, modern technology stack as depicted in the table 140 ensures scalability, reliability, flexibility, and strong domain-focused capabilities, enabling rapid innovation and efficient operational management. Collectively, the table 140 of FIG. 10 highlights a highly integrated, API-first payroll platform architecture designed for flexibility, compliance, scalability, and modern user engagement, significantly transforming traditional payroll management through advanced technology and strategic partnerships.

### Payroll Workflow Operations

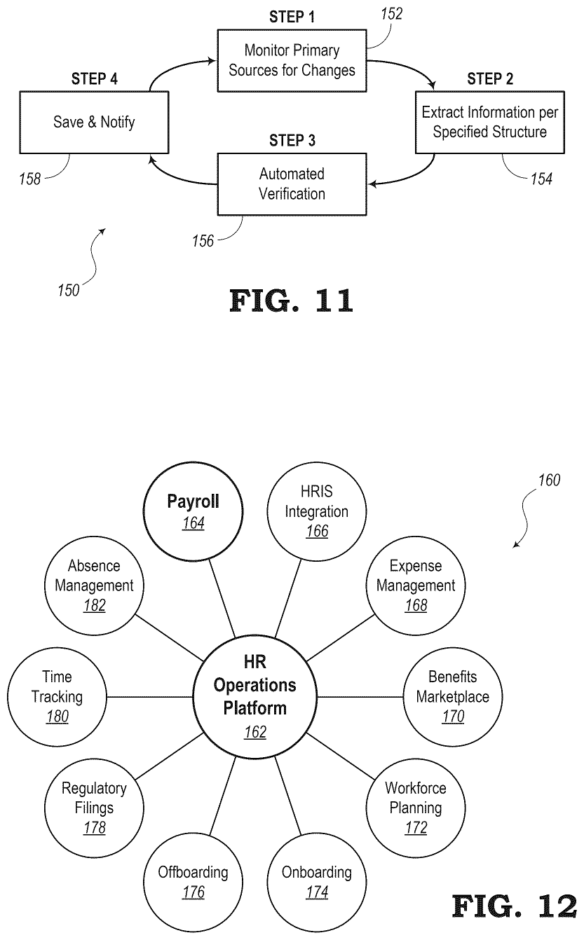

FIG. 11 illustrates an embodiment of a method 150 for executing a payroll workflow, demonstrating the rapid development and continuous refinement of payroll platform functionality using an advanced Agentic AI framework complemented by human-in-the-loop interaction via Reinforcement Learning with Human Feedback (RLHF). The method 150 of FIG. 11 highlights a cyclical, four-step automated process integrated with human validation:
Step 1 (block 152)—Monitor Primary Sources for Changes: AI-powered agents are configured to continuously monitor authoritative primary sources, such as regulatory updates, payroll laws, and procedural guidelines. This block 152 ensures the platform immediately identifies relevant changes in real-time, maintaining compliance and accuracy.
Step 2 (block 154)—Extract Information per Specified Structure: Once changes are detected, specialized AI agents systematically extract and structure the relevant information according to predefined schemas. This structured data ensures accurate, consistent interpretation and integration into the platform's computational models.
Step 3 (block 156)—Automated Verification: Extracted data is then rigorously validated by automated verification agents, employing AI-driven methods to verify accuracy, consistency, completeness, and adherence to regulatory compliance standards. This automated step rapidly identifies potential inaccuracies or inconsistencies, significantly enhancing reliability.
Step 4 (block 158)—Save & Notify: Verified and validated data is securely saved within the system's data repository. Simultaneously, notification agents alert relevant stakeholders or subsequent processes about updates, ensuring seamless downstream processing and proactive user communication.

This cyclical agent-based workflow of the method 150 is augmented through explicit human-in-the-loop interactions (RLHF):
Validation UI (Human Validation): Human experts interact with a dedicated validation user interface, reviewing extracted and verified data. Humans provide critical feedback, corrections, or additional validations, which are subsequently fed back into the AI model to refine accuracy and performance continuously. This approach ensures the nuanced human judgment required for the highest levels of accuracy and compliance, particularly in complex edge cases that automated agents alone may not handle effectively.
Customer-Facing API: Once fully validated by both automated agents and human reviewers, the refined, accurate, and compliant data is made available through customer-facing APIs. This step allows end-users—employees, employers, and partners—to access validated data seamlessly, ensuring reliability and trust in payroll outcomes.

The supporting technology stack depicted at the bottom includes:
PydanticAI, Anthropic Claude, ChatGPT (OpenAI): Providing advanced AI-driven language and extraction capabilities.
FastAPI, Python: Enabling robust, scalable, and rapid API-based development.
Supabase, PostgreSQL: Securely storing and managing structured data with high scalability and performance.
Railway, Vercel: Offering seamless, scalable deployment and infrastructure management, facilitating rapid iteration and continuous deployment.

### Expansion of HCM and HR Systems

The embodiments of the present disclosure provide improvements and benefits over conventional systems. With respect to positioning the AI-based payroll processing platform as a central component within a broader HR operations platform, the systems and methods described herein are configured to emphasize the payroll aspect as a pivotal function interconnected seamlessly with other essential HR capabilities, forming an integrated, cohesive HR ecosystem. In some respects, the systems and methods of the present disclosure may be incorporated in the HCM and HR system shown in FIG. 1 and may include one or more of the same or similar components.

FIG. 12 is a diagram illustrating an embodiment of an HR system 160. At the center of the HR system 160, an HR Operations Platform 162 is arranged, serving as a unified hub orchestrating multiple operational functionalities essential to comprehensive human capital management. Surrounding this core platform are various interconnected modules:
Payroll 164: Again, the payroll module may be a fundamental importance (as in FIG. 1) and strategic centrality within the HR operations ecosystem. It leverages AI-driven automation for accurate payroll calculation, compliance management, and reporting, reducing complexity and enhancing employee satisfaction.
HRIS Integration 166: Seamless integration with Human Resource Information Systems ensures consistent and synchronized employee data across all HR processes, enhancing accuracy and efficiency.
Expense Management 168: Efficient handling of employee expenses, integrated directly with payroll to ensure timely reimbursement and accurate financial reporting.
Benefits Marketplace 170: Centralized management of employee benefits enrollment and administration, tightly integrated with payroll to facilitate accurate deduction calculations and regulatory compliance.
Workforce Planning 172: Strategic management of staffing requirements, budgeting, and forecasting, utilizing data insights from payroll and HR analytics to optimize resource allocation.
Onboarding 174: Streamlined processes for integrating new employees into the organization, ensuring immediate synchronization with payroll, benefits, and compliance systems.
Offboarding 176: Efficient management of employee exit processes, including final payroll calculations, benefits adjustments, regulatory compliance, and documentation.
Regulatory Filings 178: Automated compliance management across various jurisdictions, tightly integrated with payroll and benefits administration to ensure timely, accurate filings with regulatory agencies.
Time Tracking 180: Accurate and automated tracking of employee hours, overtime, leave, and attendance data, directly feeding into payroll processes for precise compensation calculation.
Absence Management 182: Systematic management of employee leave requests, approvals, tracking, and integration with payroll, ensuring accurate deductions and compliance with labor regulations.

By emphasizing payroll 164 as a central function, the diagram emphasizes its integration and pivotal role within the wider HR operations infrastructure of the HR system 160. This interconnected design enables comprehensive data sharing, streamlined processes, improved operational efficiency, enhanced compliance, and an elevated employee experience, demonstrating the strategic advantages of embedding the AI-based payroll platform within a larger HR operations platform.

Additionally, it is important to highlight that the core technology underpinning the AI-based payroll platform—referred to as the “LLM Sandwich for Payroll”—has broader applicability across various other domains within the HR Operations Platform. Specifically, this technology can serve as a unified computational framework capable of orchestrating multiple critical HR functionalities beyond payroll, such as benefits administration, time tracking, absence management, onboarding, offboarding, and compliance management. By leveraging the deterministic computational capabilities integrated with probabilistic LLM-based interactions, the “LLM Sandwich” can significantly enhance efficiency, accuracy, and transparency across the entire spectrum of human capital management operations.

### AI-based Payroll Processing Method

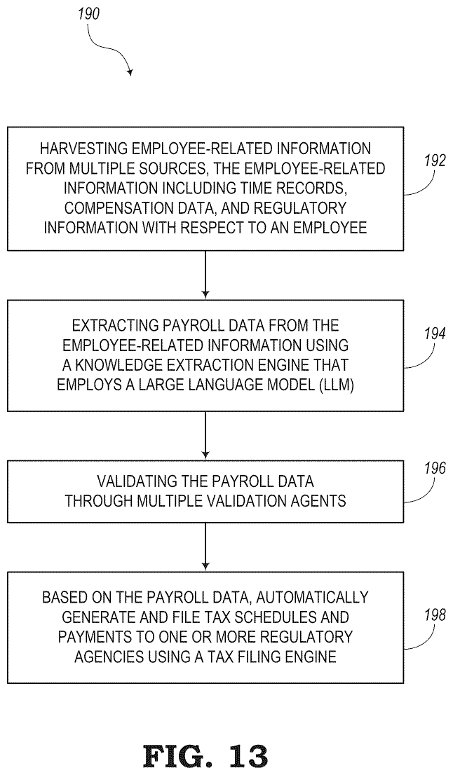

FIG. 13 is a flow diagram illustrating an embodiment of a method 190 for performing automated payroll processing operations, such as by the use of AI. The method 190 includes a step of harvesting employee-related information from multiple sources, as indicated in block 192. The employee-related information, for instance, includes time records, compensation data, and regulatory information with respect to an employee. Also, the method 190 includes a step of extracting payroll data from the employee-related information using a knowledge extraction engine that employs a Large Language Model (LLM), as indicated in block 194. The method 190 further includes a step of validating the payroll data through multiple validation agents, as indicated in block 196. Based on the payroll data, the method 190 also includes a step of automatically generating and filing tax schedules and payments to one or more regulatory agencies using a tax filing engine, as indicated in block 198.

In some embodiments, the multiple validation agents may include a) an Artificial Intelligence (AI) completeness agent that ensures extracted payroll data includes regulatory details for compliance, b) an LLM judge agent that evaluates the logical consistency and accuracy of structured payroll data extracted from natural language regulatory inputs by employing semantic accuracy evaluation, and/or c) a domain-expert agent. Also, in some implementations, the method 190 may further include steps of a) converting the time records to a gross compensation amount using a time-to-gross engine, and b) refining the gross compensation amount to a net amount based on employee-specific deductions using a gross-to-net engine.

The method 190, in some embodiments, may also include steps of a) generating a computational state graph from the validated structured payroll data, and b) executing deterministic payroll calculations using the computational state graph to determine gross pay, applicable taxes, deductions, and net pay. Furthermore, the method 190 may include enabling user interactions through a Natural Language Processing (NLP) LLM interface configured to answer payroll-related queries by retracing stages in the computational state graph. According to some embodiments, the method 190 may further include a step of performing automated verification of payroll calculations using a constraint verification algorithm integrated within the computational state graph. The computational state graph, for example, may include nodes representing sequential payroll calculation procedures including one or more of a) gross pay determination, b) deduction computations, and c) net pay calculations.

According to some implementations, the payroll-related data may include multilingual regulatory documents and global procedural texts to manage payroll regulations based on a location of the employee and a location of an employer. In some embodiments, the method 190 may further include a step of providing real-time updates to one or more of a) the knowledge extraction engine, b) the LLM, and c) the multiple validation agents in response to detected changes in regulatory compliance requirements. The step of validating the payroll data, for instance, may further include human feedback using a Reinforcement Learning with Human Feedback (RLHF) agent to enhance AI model accuracy and reliability.

The step of automatically generating and filing tax schedules and payments (block 198) may also include determining tax obligations at local, state, and federal jurisdictional levels based on executed deterministic payroll calculations. In some embodiments, the method 190 may also include a step of integrating payroll calculations and outcomes into an HR operations platform interconnected with modules for time tracking, absence management, onboarding, offboarding, and benefits management. Also, the method 190, in some embodiments, may include a step of automatically alerting stakeholders to payroll data changes and regulatory updates via notification agents. The employee-related information, according to some implementations, may be harvested from employee portals, employer portals, and partner portals via standardized Application Programming Interfaces (APIs). Furthermore, the method 190 may also include a step of continuously refining AI agent performance through iterative feedback loops involving automated agents and human reviewers.

### Knowledge Capture System

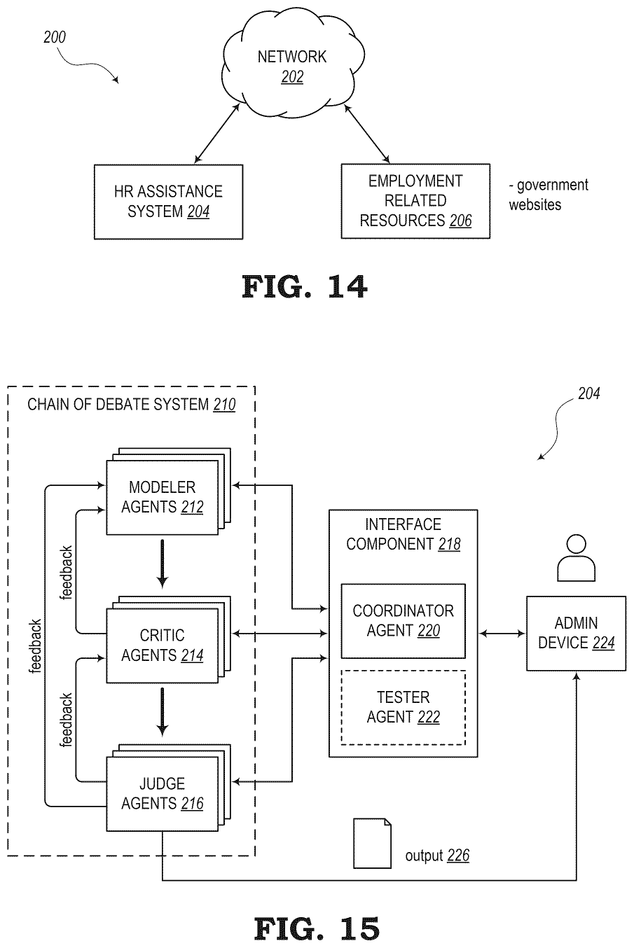

FIG. 14 is a block diagram illustrating an embodiment of a knowledge capture system 200, which may be referred to as a resource retrieval system. In some embodiments, the knowledge capture system 200 may execute the same or similar functionality as described above with respect to the knowledge capture element 72 shown in FIG. 5, the knowledge engine 80 of FIG. 6, and the like. Also, according to some embodiments, the knowledge capture system 200 may be configured with the same or similar components as described with respect to the knowledge capture element 72, knowledge extraction LLM 84, and/or at least one of the multiple AI validation agents 86 shown in FIG. 6.

As illustrated in the embodiment of FIG. 14, the knowledge capture system 200 includes a network 202 (e.g., the Internet, the network 46, etc.) to enable communication between organizational-based entities and worldwide governmental-based entities responsible for enacting employment regulations. Also, the knowledge capture system 200 includes an HR assistance system 204 configured as one of perhaps many organizational-based entities for assisting HR personnel with employment laws and regulations for a company or organization. The knowledge capture system 200 further includes employment related resources 206, such as government websites from which information about employment laws, rules, regulations, etc. can be obtained. The employment related resources 206 may include websites/sources regarding various categories associated with employment, such as those depicted in FIGS. 1 and 12. In addition to official governmental sources, the employment related resources 206 may also include various unofficial websites pertaining to employment laws, rules, and regulations that may be applicable to various jurisdictions (e.g., countries, states, territories, etc.) of interest throughout the world.

In operation, the HR assistance system 204 may be configured to retrieve various employment resources to perform knowledge capture functionality within the knowledge capture system 200. In particular, a company wishing to obtain employment regulations for Canada may access the employment related resources 206 associated with valid government agencies of Canada responsible for employment law. In response to obtaining updated employment laws and regulations, the HR assistance system 204 can effectively assist the respective HR team to conduct or enforce various employment policies with respect to a number of employees within the company.

### HR Assistance System

FIG. 15 is a block diagram illustrating an embodiment of the HR assistance system 204 shown in FIG. 14. As shown, the HR assistance system 204 includes a chain of debate system 210, which includes one or more modeler agents 212, one or more critic agents 214, and one or more judge agents 216. Also, the HR assistance system 204 includes an interface component 218 connected to the chain of debate system 210, wherein the interface component 218 includes a coordinator agent 220 and a tester agent 222. The HR assistance system 204 further includes an admin device 224 connected to the interface component 218. The agents, as described herein, may include AI agents (e.g., LLM agents) and/or non-AI agents (e.g., non-LLM agents, such as algorithms, code, scripts, etc.).

A user of the admin device 224 may wish to initiate an employment regulation search or knowledge capture to obtain employment regulations. In some embodiments, the chain of debate system 210 may be configured to automatically obtain employment regulations from multiple sources, either in response to an instruction from the admin device 224 or automatically to monitor for changes in employment regulations. The interface component 218 may be configured to interact between the admin device 224 and chain of debate system 210 to forward user instructions to the chain of debate system 210, to ask for clarification or instructions from the user when the chain of debate system 210 is unable to reach a reasonable conclusion (or other reasons), to send an output 226 and other suitable results of the chain of debate system 210 to the admin device 224 when captured employment regulations are properly formatted or organized according to the user's liking, etc.

The concept of “Chain of Debate” (CoD) refers to a system (e.g., an AI-based system) having multiple agents (e.g., AI agents) that work together to achieve more accurate results in response to a user query or prompt. The agents in a CoD can approach a problem from many different angles, create an automated “dialogue” amongst themselves, argue, debate, collaborate, etc. They may use a Mixture of Experts (MoE) at each of the three stages (e.g., the first stage being a modeler stage, the second stage being a critic stage, and the third stage being a judge stage), wherein an MoE approach uses the same input to all agents, but each agent uses a different processing method for providing outputs. In some embodiments, the agents in one stage may use an ensemble learning technique, a committee technique, an automated dialogue technique, etc. to reach a converging consensus.

The CoD approach provides benefits over typical solo thinking (e.g., chain of thought) that can use a serial-type, or step-by-step processing pipeline. The neural network arrangement of agents in a CoD system can handle complex situations with more accuracy and reliability. The various agents of CoD can be structured with specialized roles or voices, as is shown in FIG. 15. For example, an “optimist” agent can explore multiple opportunities, a “skeptic” agent can raise concerns and assess risks, a “budgeter” agent can analyze cost or value, and so on. By arranging the agents in a mesh-like neural network (e.g., with feedback), the agents can interact with each other to reason, critique, challenge, refine, and/or share processing loads. Thus, the agents of the chain of debate system 210 create a more advanced technique of processing information (e.g., employment regulations), whereby the multiple agent can debate each other to improve reasoning and accuracy, with diverse agents potentially outperforming single, powerful models. This approach leverages the collective intelligence of multiple agents to reach more robust and reliable conclusions.

In addition, in order to obtain a diverse set of algorithms and strategies, the various agents of the chain of debate system 210 may be related to different AI, GenAI, or LLM chatbots. For example, a combination of any of a number of chatbots may include ChatGPT (developed by OpenAI), Gemini (developed by Google), Copilot (developed by Microsoft), Claude (developed by Anthropic), Grok (developed by xAI, previously developed by X formerly known as Twitter), among other AI or LLM systems.

The one or more modeler agents 212 of the chain of debate system 210 can be configured to implement processes for modeling employment regulations. The results of this modeling can be passed to the second stage, where the one or more critic agents 214 can analyze or critique the employment regulations.

In some embodiments, the one or more critic agents 214 may include a “syntax” agent for analyzing syntax, a “validity” agent or “rules” agent for analyzing accuracy or compliance, a “completeness” agent for analyzing whether all applicable employment regulations are addresses, a “ranking” agent for ranking or rating the results of this second stage, and/or other agents as needed for critiquing or analyzing employment regulations in the HR assistance system 204. If the ranking is low, the second stage (i.e., the critic stage) may send instructions as feedback to the first stage to request more accurate, updated, or otherwise healthier information.

After the second stage, the results are passed to the third stage (i.e., the judge stage) where the one or more judge agents 216 perform judgements on the employment information. Based on results of the judging functions, the third stage may provide instructions and feedback to either or both of the first or second stages to request for clarifications and/or updates. Once a final document or set of employment regulations is obtained that is suitable, as defined according to various predetermined criteria, the judge stage can provide the output 226 to the admin device 224 (e.g., via the interface component 218), wherein the employment information can thereby be put into production for providing the various HR and employment services as described with respect to FIGS. 1 and 12.

It should be noted that employment-related information (e.g., laws, rules, regulations, etc.) for various components of an employment environment is typically meant for human interpretation. However, this information is often not straightforward but may be ambiguous and difficult to understand. For example, reading instructions on how to fill out tax forms for the Internal Revenue Service (IRS) can be quite complex for the typical taxpayer. As an example of IRS tax rules, it may be readily understood that one AI agent might interpret the rules one way, while another AI agent might interpret the rules in a completely different way. At times, some agents may even create hallucinations as a result of analyzing such complex material. Therefore, by checking and rechecking each other, the agents of the chain of debate system 210 can discover hallucinations or other incidents of defective analysis processes. In this case, they can describe how mistakes have been made, give recommendations on how certain passages of the information should be interpreted, make corrections, provide assistance on certain points, etc.

In a first step, the HR assistance system 204 may perform an extraction step from the employment related resources 206. This can be from employment law all over the world. This may include info that is useful and compliant for handling various areas of employment or HR (e.g., payroll). The employment regulations and such may include governmentally established laws, rules, rules of thumb, thresholds (e.g., income tax brackets), disability laws, etc.

In addition to widespread laws and rules (e.g., within each particular jurisdiction), the extraction phase may further include obtain company-specific policies and rules. For example, these policies and rules may be applicable to specific companies, businesses, organizations, etc. or groups thereof. These policies may include employee contract information, collective bargaining agreements, benefits, etc.

According to some embodiments, the extraction step may be performed by the one or more modeler agents 212. Alternatively, the extraction may be performed before the chain of debate system 210 takes over. A next step after extraction may include obtaining (further extracting) the relevant content of a large amount of data. After this, the second stage (e.g., the critic stage) may be configured to critique or check the validity of the extracted material or content and return a rating along with issues in the extraction or understanding of the employment information. This may be placed in a human-readable format (e.g., YAML, JSON, etc.). In some cases, poor ratings may cause the one or more critic agents 214 to provide feedback to the one or more modeler agents 212 for clarifications, revisions, etc. Again, the critic roles may include Syntax, Rules, Completeness, and/or other specifically configured agents. like.

The third stage may include agents or LLMs related to the judgement stage for assessing the results at this point to determine if the results are reliable to a reasonable degree. If not, the one or more judge agents 216 may provide feedback to the one or more modeler agents 212 or the one or more critic agents 214, as needed.

The coordinator agent 220 may be configured to coordinate the various responsibilities and roles of each stage and/or individual agent, but it can also provide suitable prompts for defining how each agent and/or stage is meant to perform, according to number of specifications. Also, the coordinator agent 220 can keep the user of the admin device 224 in the loop as needed for human clarification or “idiot-proofing” as needed to reduce obvious errors that might not be noticed by non-human agents.

The tester agent 222 is configured to provide testing of the output 226 when desired. For example, in response to a request from the admin device 224, the chain of debate system 210 may be configured to take the output 226, along with sample employment information or situations, and perform a test. The test, for example, can determine if the output 226 accurately and reliably captures the employment regulations in the knowledge capture procedure described herein. In some embodiments, the test may include real-world data (e.g., related to a group of employees), or, alternatively, may include fictional employee information. Also, according to some implementations, the test may be performed in a sandbox environment to separate the results from real-world consequences.

### Agent Instructing System

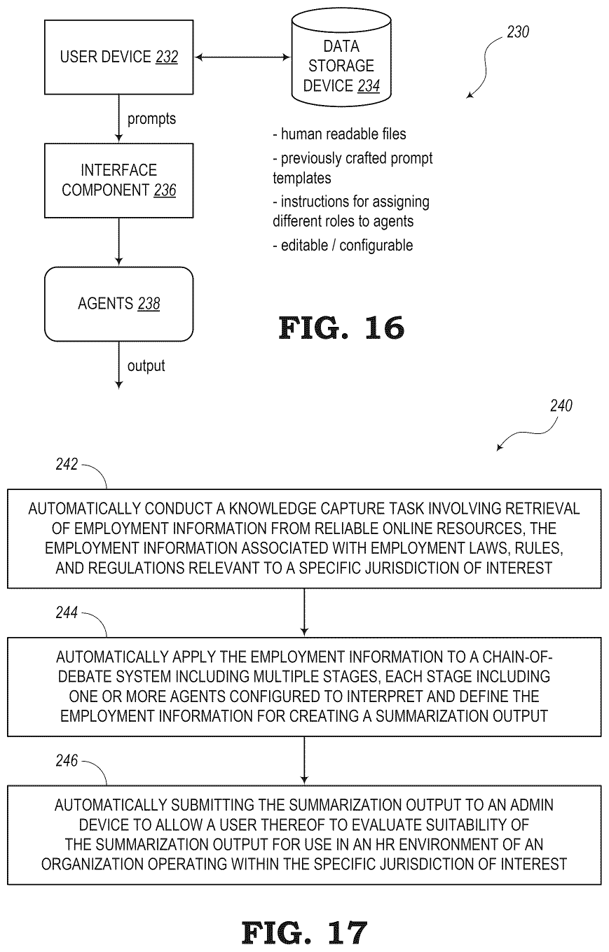

FIG. 16 is a block diagram illustrating an embodiment of an agent instructing system 230. As illustrated in this embodiment, the agent instructing system 230 includes a user device 232 (e.g., admin device 224) which is configured to access a data storage device 234 or other suitable memory component for storing components, scripts, prompts, etc. that can be used for creating, editing, configuring, fine-tuning prompts that can be provided to LLMs or other AI agents or systems. For example, the data storage device 234 may be configured to store human readable files (e.g., YAML files, JSON files, etc.), previously crafted prompt templates, instructions for assigning different roles to various agents of the chain of debate system 210, etc. The information stored therein may be editable and/or configurable as needed for updating based on new employments laws, fine-tuning the agent processing as needed to better fit the intentions of each agent, or for other various reasons.

The following is an example of a prompt that may be applied to the chain of debate system 210 for extracting and/or summarizing employment regulations. This prompt may be crafted from various template elements that might be similar across multiple jurisdictions, whereby a user can apply simple customization to the templates to craft various parts of the prompt. Also, the following JSON example is specifically crafted for use by the one or more modeler agents 212 for extracting and analyzing German employment regulations:

```
modeler:
      prompt:
            You are an expert at extracting basic allowance (Grundfreibetrag) logic from
      German text authority programming manuals.
            DOCUMENT CONTENT:
            {component_text}}
            DSL SPECIFICATION AND GUIDELINES:
            {{dsl_yaml}
      EXTRACT BASIC ALLOWANCE INFORMAITON FROM THE
DOCUMENT:
      1. FIND basic allowance amount:
      - Look for “Grundfreibetrag” or “basic allowance” references
      - May be abbreviated as “GFB” in technical documents
      - Extract the exact monetary amounts mentioned
      - Note the tax year or period this applies to
      - Check for any variations or updates mentioned
      2. ANALYZE allowance application:
      - How is the basic allowance applied in the tax calculations?
      - Is it deducted from gross income or applied differently?
      - Are there conditions or eligibility requirements?
      - Does it vary by filing status or other factors?
      3. IDENTIFY special rules:
      - Are there different allowances for different taxpayer categories?
      - Any regional variations or exceptions?
      - How does it interact with other tax components?
      - Are there any phase-out or limitation rules?
      4. FIND calculation methodology:
      - How is taxable income calculated using the allowance?
      - What happens when income is below the allowance?
      - Are there any rounding rules or special procedures?
      5. CREATE YAML state machine based on DISCOVERED
information:
      - Use the actual allowance amount found in the document
      - Implement the specific application logic described
      - Handle any conditional logic or special cases
      - Ensure proper integration with income calculation
      IMPORTANT EXTRACTION RULES:
      - ONLY use information actually present in the document
      - If specific values are not found, state “Not found in document”
      - Do not use any predefined allowance amounts
      - Preserve exact formatting and currency symbols from source
      - If document references external sources, note those references
      Follow DSL guidelines for structure. Return ONLY the raw YAML code.
```

Furthermore, an example of a Germany prompt for the one or more critic agents may be crafted (e.g., from templates) as follows:

```
critic:
      prompt:
      1. EXTRACTION ACCURACY:
      - Is the basic allowance amount correctly extracted from the document?
      - Does the application logic match what is specified in the source?
      - Are any critical details missing or misinterpreted?
      2. LOGICAL STRUCTURE:
      - Do the conditional transitions handle allowance applications properly?
      - Is the calculation flow logical and correct?
      - Are edge cases (income below allowance) handled appropriately?
      3. DSL COMPLIANCE:
      - Does the YAML follow required structural guidelines?
      - Are state names and transitions properly formatted?
      - Is the overall structure maintainable?
      4. COMPLETENESS:
      - Are all important allowance rules captured?
      - Is integration with income calculation properly handled?
      - Are any special conditions or variations missing?
      Return JSON format:
      {
            “rating”: 1-10,
            “is_acceptable”: true/false,
            “issues”: {
                  {
                        “aspects”: “extract_accur/logical_structure/dsl_compliance”,
                        “description”: “detailed description”,
                        “suggestion”: “specific improvement”
                  }
            },
            “strengths”: [“list of strong points”]
      }
```

Furthermore, an example of a Germany prompt for the judge agents 216 may be crafted (e.g., from templates) as follows:

```
judge:
      prompt:
            You are an expert tax bracket validator for Germany's income tax systems.
      Evaluate ONLY the tax bracket component for approval.
      {{current_yaml}}
      DSL SPECIFICATION:
      {{dsl_yaml}}
      ORIGINAL DOCUMENT:
      {component_text}}
      COMPONENT SCOPE: Tax bracket rates, thresholds, and application logic
only.
      VALIDATION CRITERIA:
      ...
```

### Method for Automatically Summarizing Employment Regulations

FIG. 17 is a flow diagram illustrating an embodiment of a method 240 for automatically retrieving and summarizing employment regulations for enforcement purposes within an organization. As shown in FIG. 17, the method 240 includes a step (block 242) of automatically conducting a knowledge capture task involving the retrieval of employment information from reliable online resources, the employment information associated with employment laws, rules, and regulations relevant to a specific jurisdiction of interest. Also, the method 240 includes a step (block 244) of automatically applying the employment information to a chain-of-debate system including multiple stages, each stage including one or more agents configured to interpret and define the employment information for creating a summarization output. The method 240 further includes a step (block 246) of automatically submitting the summarization output to an admin device to allow a user thereof to evaluate suitability of the summarization output for use in a Human Resources (HR) environment of an organization operating within the specific jurisdiction of interest.

In some embodiments, the multiple stages of the chain-of-debate system may include a modeler stage, a critic stage, and a judge stage. The critic stage, for example, may include at least a syntax agent, a rules agent, and a completeness agent. Also, according to some embodiments, a first set of agents of the modeler stage, a second set of agents of the critic stage, and a third set of agents of the judge stage may each be configured to operate according to a Mixture of Experts (MoE) technique, an ensemble learning technique, a committee technique, and/or an automated dialogue technique in order to attempt to reach a converging consensus. The modeler stage, for instance, may be configured to pass a first set of results to the critic stage, and the critic stage, for instance, may be configured to pass a second set of results to the judge stage. Also, the critic and judge stages may be configured to provide feedback to one of the previous stages as needed for clarification and/or for requesting more accurate or reliable results.

The method 240, according to some implementations, may further include a step of utilizing a coordinator agent configured between the admin device and the chain-of-debate system for enabling communication among the multiple stages of the chain-of-debate system and the admin device. Also, the method 240 may include a step of testing results of the chain-of-debate system with real-world or fictitious employment data associated with the organization. The reliable online resources include government websites, for example, may be associated with employment regulations in multiple countries, states, or territories. In some embodiments, the method 240 may further include a step of enabling a user associated with the admin device to craft prompts and agent role assigning instructions from configurable templates.

The chain-of-debate system, according to some embodiments, may include multiple agents arranged in a neural network, wherein roles of the multiple agents may include a) a knowledge capturer, b) an extractor, c) a language translator, d) a Natural Language Processor (NLP), e) a modeler, f) a critic, g) a syntax analyzer, h) a rules analyzer, i) a completeness analyzer, j) a ranking scorer, k) a judge, l) a human-in-the-loop verifier, m) a coordinator, n) a final output tester, o) a validator, and/or p) a compliance analyzer. Furthermore, the one or more agents of each of the multiple stages may include Artificial Intelligence (AI) agents employing Large Language Models (LLMs) and/or Generative AI (GenAI) models.

The knowledge capture embodiments are configured to expand upon the knowledge capture element described in FIGS. 5 and 6 for automated information extraction, focusing on employment law and tax regulations across different countries. They aim to extract specific, often ambiguous, information using an iterative process involving multiple LLMs (e.g., modeler, critic, judge) to ensure accuracy and completeness, with human oversight for ambiguous cases.

The Knowledge Capture systems and methods are configured to operate on the chain of debate techniques in different contexts. One goal, for example, is to utilize multiple language models (e.g., LLMs) in an automated dialogue to reach converging ideas for extracting data.

Automated information extraction may include the present systems and methods configured to extract specific, sometimes ambiguous, information from input sources for human interpretation. This may involve an LLM (e.g., modeler) proposing an answer based on extraction rules, followed by another LLM (e.g., the critic) evaluating the output against the source and providing feedback, including a rating. Multiple critic agents with specialized roles (e.g., syntax, validity, completeness) can be involved in this iterative process, potentially leading to convergence or requiring human intervention.

The present disclosure is applicable in employment law, wherein a major focus of the knowledge capture may include extracting key information from payroll and employment laws across different countries. This may include rules, regulations, thresholds, income tax brackets, and methods of payroll computation, which are subject to frequent changes. The systems and methods are also configured to handle company-specific agreements and policies, extracting relevant logic as long as they meet statutory requirements.

Critiquing and validation processes can be performed after the modeler has extracted information. That is, a “critic” LLM evaluates the accuracy, structure, compliance, and completeness of the extracted content, assigning a rating. If the rating is low and issues are identified, the information may be sent back to the modeler for improvement. A final “judge” layer performs additional validations after the modelers and critics reach an agreement, while disagreements can restart the entire process.

Human operators (e.g., user of the admin device 224) may provide supervision over the process. This may include clarifying vague or ambiguous information and offering a final approval, when appropriate, before the information is put into production. Other benefits of using a human-in-the-loop arrangement may be realized, such as making sure results make sense and are reasonable. In some cases, the automated AI agent system may provide a bulk of the processing and decision-making load (e.g., perhaps at 80-90%), while the user can provide administration review and control as needed. Other benefits include faster onboarding of new countries, quicker updates to changing laws, and a reduction in errors compared to manual processes. Expert review may also be eased as HR teams can primarily focus on adjudicating ambiguous items.

The embodiments of the present disclosure may also include continuous monitoring and testing. The chain of debate system 210 may configure the one or more modeler agents 212 to each take responsibility for continuously monitoring the employment related resources 206 (e.g., government websites) for changes in regulations, and then automatically triggering the extraction process. Additionally, the tester agent 22 may be configured to generate test cases, where some may be initiated by the admin device 224, some may be initiated by a customer, others may be generated by the chain of debate system 210 (e.g., any agents), and other may be generated by the interface component 218 itself. The testing can ensure the correctness of the extracted logic and test results can be supplied to the user for offering the final OK. That is, human approval may be an important part of the system before pushing any changes into production, particularly due to the compliance-sensitive nature of the work.

### Conclusion

Although the present disclosure has been illustrated and described herein with reference to various embodiments and examples, it will be readily apparent to those of ordinary skill in the art that other embodiments and examples may perform similar functions, achieve like results, and/or provide other advantages. Modifications, additions, or omissions may be made to the systems, apparatuses, and methods described herein without departing from the spirit and scope of the present disclosure. All equivalent or alternative embodiments that fall within the spirit and scope of the present disclosure are contemplated thereby and are intended to be covered by the following claims.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A method comprising steps of:
automatically conducting a knowledge capture task involving retrieval of employment information from reliable online resources, the employment information associated with employment laws, rules, and regulations relevant to a specific jurisdiction of interest;
automatically applying the employment information to a chain-of-debate system including multiple stages, each stage including one or more agents configured to interpret and define the employment information for creating a summarization output; and
automatically submitting the summarization output to an admin device to allow a user thereof to evaluate suitability of the summarization output for use in a Human Resources (HR) environment of an organization operating within the specific jurisdiction of interest.

2. The method of claim 1, wherein the multiple stages of the chain-of-debate system include a modeler stage, a critic stage, and a judge stage.

3. The method of claim 2, wherein the critic stage includes at least a syntax agent, a rules agent, and a completeness agent.

4. The method of claim 2, wherein a first set of agents of the modeler stage, a second set of agents of the critic stage, and a third set of agents of the judge stage are each configured to operate according to a Mixture of Experts (MoE) technique, an ensemble learning technique, a committee technique, and/or an automated dialogue technique in order to attempt to reach a converging consensus.

5. The method of claim 2, wherein the modeler stage is configured to pass a first set of results to the critic stage, and the critic stage is configured to pass a second set of results to the judge stage.

6. The method of claim 2, wherein the critic and judge stages are configured to provide feedback to a previous stage as needed for clarification and/or for requesting more accurate or reliable results.

7. The method of claim 1, further comprising a step of utilizing a coordinator agent configured between the admin device and the chain-of-debate system for enabling communication among the multiple stages of the chain-of-debate system and the admin device.

8. The method of claim 1, further comprising a step of testing results of the chain-of-debate system with real-world or fictitious employment data associated with the organization.

9. The method of claim 1, wherein the reliable online resources include government websites associated with employment regulations in multiple countries, states, or territories.

10. The method of claim 1, further comprising a step of enabling a user associated with the admin device to craft prompts and agent role assigning instructions from configurable templates.

11. The method of claim 1, wherein the chain-of-debate system includes multiple agents arranged in a neural network, and wherein roles of the multiple agents includes one or more of a) a knowledge capturer, b) an extractor, c) a language translator, d) a Natural Language Processor (NLP), e) a modeler, f) a critic, g) a syntax analyzer, h) a rules analyzer, i) a completeness analyzer, j) a ranking scorer, k) a judge, l) a human-in-the-loop verifier, m) a coordinator, n) a final output tester, o) a validator, p) a compliance analyzer, and q) a regulation updater.

12. The method of claim 1, wherein the one or more agents of each of the multiple stages include Artificial Intelligence (AI) agents employing Large Language Models (LLMs) and/or Generative AI (GenAI) models.

13. A Human Resources (HR) assistance system comprising:
a processing device; and
memory configured to store computing logic having instructions that, when executed, enable the processing device to
automatically conduct a knowledge capture task involving retrieval of employment information from reliable online resources, the employment information associated with employment laws, rules, and regulations relevant to a specific jurisdiction of interest,
automatically apply the employment information to a chain-of-debate system including multiple stages, each stage including one or more agents configured to interpret and define the employment information for creating a summarization output, and
automatically submit the summarization output to an admin device to allow a user thereof to evaluate suitability of the summarization output for use in a Human Resources (HR) environment of an organization operating within the specific jurisdiction of interest.

14. The HR assistance system of claim 13, wherein the multiple stages of the chain-of-debate system include a modeler stage, a critic stage, and a judge stage.

15. The HR assistance system of claim 14, wherein a first set of agents of the modeler stage, a second set of agents of the critic stage, and a third set of agents of the judge stage are each configured to operate according to a Mixture of Experts (MoE) technique, an ensemble learning technique, a committee technique, and/or an automated dialogue technique in order to attempt to reach a converging consensus.

16. The HR assistance system of claim 14, wherein the modeler stage is configured to pass a first set of results to the critic stage, and the critic stage is configured to pass a second set of results to the judge stage, and wherein the critic and judge stages are configured to provide feedback to a previous stage as needed for clarification and/or for requesting more accurate or reliable results.

17. The HR assistance system of claim 13, further comprising a coordinator agent configured between the admin device and the chain-of-debate system for enabling communication among the multiple stages of the chain-of-debate system and the admin device.

18. The HR assistance system of claim 13, further comprising a tester agent configured to test results of the chain-of-debate system with real-world or fictitious employment data associated with the organization.

19. A non-transitory computer-readable medium configured to store logic having instructions that causes one or more processing devices to perform steps of:
automatically conduct a knowledge capture task involving retrieval of employment information from reliable online resources, the employment information associated with employment laws, rules, and regulations relevant to a specific jurisdiction of interest,
automatically apply the employment information to a chain-of-debate system including multiple stages, each stage including one or more agents configured to interpret and define the employment information for creating a summarization output, and
automatically submit the summarization output to an admin device to allow a user thereof to evaluate suitability of the summarization output for use in a Human Resources (HR) environment of an organization operating within the specific jurisdiction of interest.

20. The non-transitory computer-readable medium of claim 19, wherein the one or more agents of each of the multiple stages include Artificial Intelligence (AI) agents employing Large Language Models (LLMs) and/or Generative AI (GenAI) models, wherein the chain-of-debate system includes multiple agents arranged in a neural network, and wherein roles of the multiple agents includes one or more of a) a knowledge capturer, b) an extractor, c) a language translator, d) a Natural Language Processor (NLP), e) a modeler, f) a critic, g) a syntax analyzer, h) a rules analyzer, i) a completeness analyzer, j) a ranking scorer, k) a judge, l) a human-in-the-loop verifier, m) a coordinator, n) a final output tester, o) a validator, p) a compliance analyzer, and q) a regulation updater.
